(19) United States
(12) Patent Application Publication
(10) Pub. No.: US 2021/0281131 A1
(43) Pub. Date: Sep. 9, 2021

(54) PERMANENT MAGNET ENGINE

(71) Applicant: William James McKee, JR., Tiburon, CA (US)

(72) Inventor: William James McKee, JR., Tiburon, CA (US)

(21) Appl. No.: 17/328,938

(22) Filed: May 24, 2021

(51) Int. Cl. H02K 1/27; H02K 1/17

(52) U.S. Cl. CPC H02K 1/278; H02K 2213/09; H02K 2213/03; H02K 1/17

(57) ABSTRACT

Disclosed embodiments may include a permanent magnet system that will move rotor assembly with respect to the position of a stator assembly. A stator assembly may be stationary and take the form of a circular system while a rotor assembly may be magnetically urged in rotational movement within the stator assembly. Both the rotor and stator assemblies may be populated with permanent magnet pole pieces such that the rotating magnetic field of the rotor interacts with the static magnetic field of the stator and thereby achieves a magnetic interaction that urges rotation of the rotor assembly. By virtue of the moving magnetic fields of the rotor, positions of the rotor and stator magnets, the attraction to repulsion forces of the rotor magnets may be uneven and thus add to the rotational energy of the rotor.

### COPYRIGHT AND TRADEMARK NOTICE

This application includes material which is subject or may be subject to copyright and/or trademark protection. The copyright and trademark owner(s) has no objection to the facsimile reproduction by any of the patent disclosure, as it appears in the Patent and Trademark Office files or records, but otherwise reserves all copyright and trademark rights whatsoever.

### BACKGROUND OF THE INVENTION

### Field of the Invention

The invention generally relates to systems and methods of increasing mechanical efficiency by use of static and moving magnetic fields. More particularly, the invention relates to the use of magnetic forces to urge movement of a rotor within or near a stator.

### Brief Summary of the Invention

The present invention overcomes shortfalls in the related art by presenting an unobvious and unique combination, configuration and use of disclosed rotors rotating within or near disclosed stators with such rotation urged or assisted by moving magnetic fields of the rotor in combination with stationary magnetic fields of the stator.

A rotor assembly may be circular in shape and comprise a plurality of pole magnet pieces artfully disposed at various angles along the x, y axis of a rotor plate with the rotor pole pieces creating a plurality of moving magnetic fields that may in magnetic contact and in an off balanced attraction or repulsion ratio with the plurality of static magnetic fields of the stator assembly. The disclosed embodiments may assist in extending the rotational duration of a rotor disposed within or adjacent to a stator assembly.

In other disclosed embodiments, a plurality of rotor assemblies may share a common center axis and be housed within or near a single stator or a plurality of stators or stator assemblies.

### BRIEF DESCRIPTION OF THE DRAWINGS

FIG. 1 is a plan view of a rotor assembly

FIG. 2 is a plan view of various stator components near a rotor

FIG. 3A is perspective view of a rotor magnet adjacent to a stator magnet

FIG. 3B is a perspective view of a rotor magnet adjacent to an angled stator magnet

FIG. 3C is a perspective view of a rotor magnet and various positions of a stator magnet

FIG. 4 is a graph

FIG. 5 is a perspective and cut away view of a disclosed series of rotors

FIG. 6 is a plan view of a rotor in relation to stator magnets in various positions

### REFERENCE NUMERALS IN THE DRAWINGS

101 rotor plate comprising non-ferromagnetic material

102 center void defined within rotor plate 101

103 rotor magnetic pole piece

104 dark marking or other indicia indicating a North polarity

201 stator assembly

202 stator magnetic pole piece

203 central open space defined within a stator sometimes used to accommodate a rotor

204 dark band disposed upon a stator magnet, sometimes used to denote North

207 body of stator

501 a plurality of rotors within a housing

502 a common shaft

503 a plurality of stators sometimes mated, attached or near a plurality of rotors

504 electro-magnetic pickup

601 turning or adjustment of a stator magnet

602 fixed point

603 air gap or void sometimes defined by the distance between a rotor pole piece and a stator pole piece

604 change in distance between a stator magnet and rotor magnet

These and other aspects of the present invention will become apparent upon reading the following detailed description in conjunction with the associated drawings.

### DETAILED DESCRIPTION OF EMBODIMENTS OF THE INVENTION

The following detailed description is directed to certain specific embodiments of the invention. However, the invention can be embodied in a multitude of different ways as defined and covered by the claims and their equivalents. In this description, reference is made to the drawings wherein like parts are designated with like numerals throughout.

Unless otherwise noted in this specification or in the claims, all of the terms used in the specification and the claims will have the meanings normally ascribed to these terms by workers in the art.

Unless the context clearly requires otherwise, throughout the description and the claims, the words “comprise,” “comprising” and the like are to be construed in an inclusive sense as opposed to an exclusive or exhaustive sense; that is to say, in a sense of “including, but not limited to.” Words using the singular or plural number also include the plural or singular number, respectively. Additionally, the words “herein,” “above,” “below,” and words of similar import, when used in this application, shall refer to this application as a whole and not to any particular portions of this application.

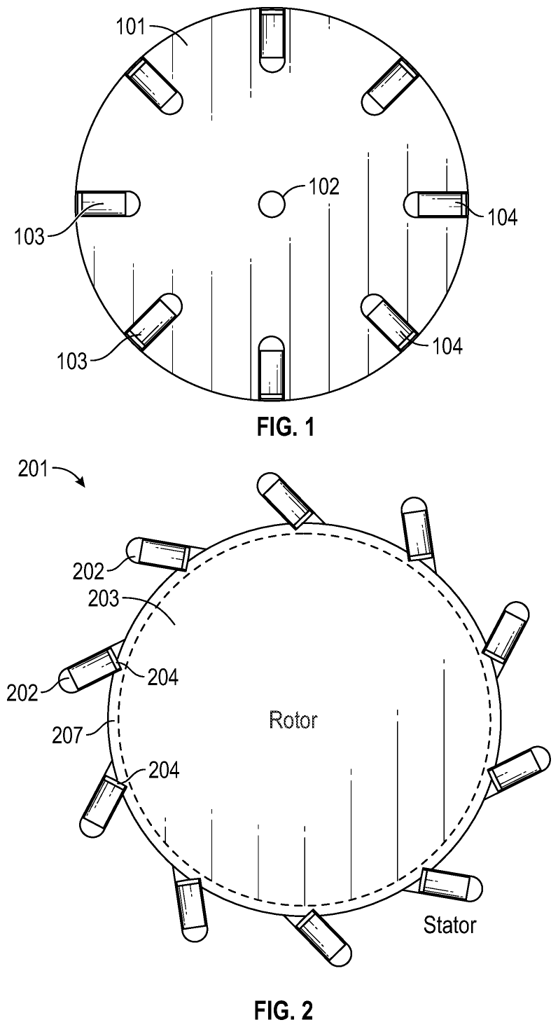

Referring to FIG. 1, a rotor platen assembly may comprise a rotor plate 101, with the rotor plate comprising or made of a non-ferromagnetic material. A rotor plate may be comprise a plurality of equally spaced permanent magnets sometimes referred to as “rotor pole pieces” or rotor magnets 103. Rotor magnets may have end areas sometimes disposed near the edge of the rotor and sometimes referred to as North ends 104.

Rotor magnets 103 or rotor pole pieces may be radially aligned with respect to the rotational axis of the rotor and arranged about the outer circumference of the rotor body with all the “like” (North) magnetic poles shown as a dark band or double band 104, facing outwardly toward the location where the stator assembly will reside. The central void 102 may be used to accommodate the shaft upon which the rotor will be fastened upon assembly.

Referring to FIG. 2, a stator platen assembly 201 is shown outside of or behind a rotor. A stator platen assembly may comprise a non-ferromagnetic material body, 207 in which the several “Stator Pole-Pieces” or stator magnets 202, are equally spaced and arranged around the central open space 203, wherein the rotor will reside. The stator pole-pieces or stator magnets all have the “like” (North) magnetic poles denoted by a dark band or double band lines 204, facing inward toward the space to be occupied by the rotor assembly. The stator pieces or stator magnets depicted herein are “turned” to a 45-degree angle with respect to the radial of the central axis about which the rotor will be turning.

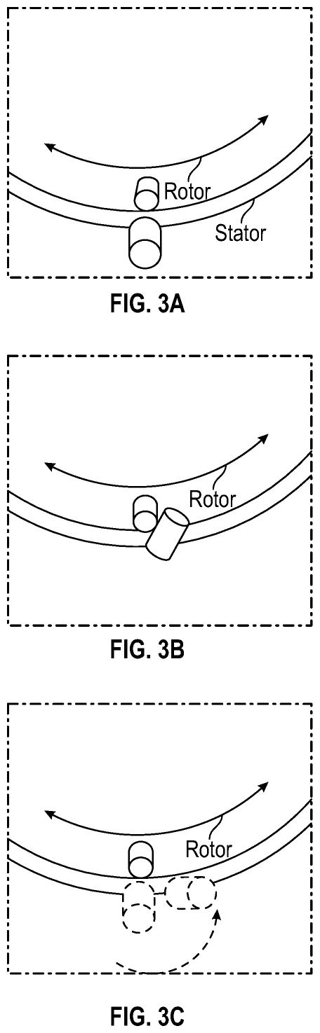

Referring to FIG. 3A, an expanded rotor and stator edge section is shown with magnets disposed in a simple radial alignment.

FIG. 3B depicts a stator magnet in a 45 degree angle along the z axis.

FIG. 3C depicts a stator magnet is shown in various positions to demonstrate the possibility of selecting and executing angular attitude with respect to the rotating rotor platen. The pole-pieces or magnets are shown mounted atop to the platens for simplicity of explanation.

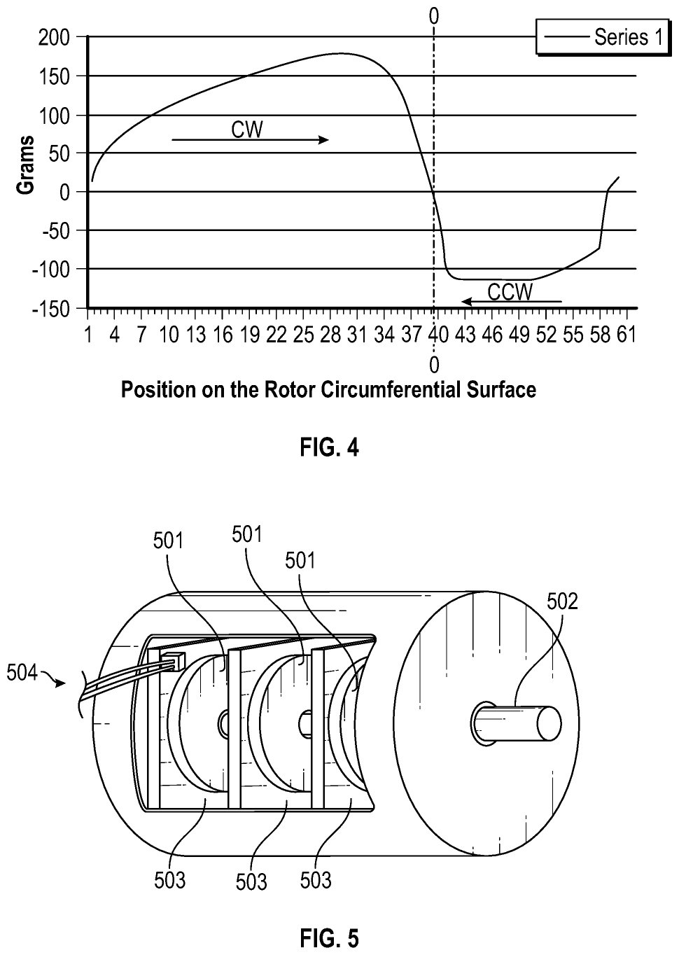

FIG. 4 is a graph showing an example of resultant forces. A resultant force may be considered a force in an engine rotor-stator interaction, using a single pole pair (one rotor and one stator pole-piece each), as shown. The graph shows the tangential force relationship generated, measured in grams, as the rotor is moved in both the CW and CCW rotational directions through the maximum magnetic interaction point of the two pole-pieces. The vertical or y axis denotes weight in grams. The horizontal or x axis denotes the position of a rotor in degrees at the rotor's circumference.

FIG. 5 depicts a sectional or cut away view of a disclosed system having a plurality of rotors and stators disposed within a housing. A disclosed system or engine may comprise a plurality of rotors, 501, affixed to a common shaft 502, and mated stators, 503, wherein the full output force of the engine can be planned to complement particular applications. An electro-magnetic pickup, 504, is shown in a possible mounting location to provide a usable electrical representation of the system's rotational speed.

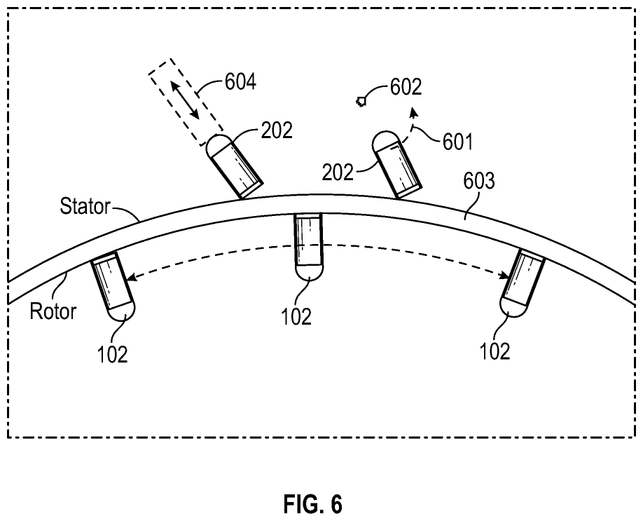

FIG. 6 depicts a magnetic air gap between the rotor and stator poles. FIG. 6 depicts two of the possible means used to adjust the effective magnetic “air-gap”, 603, realized between the rotor pole-pieces, 102, and the stator pole-pieces, 202. A turning shown, 601, of the stator pole-pieces about some fixed point, (602), or a simple increase in the interaction gap by moving the stator pole-pieces directly away from the rotor assembly, 604, are both shown.

### FURTHER DESCRIPTION OF THE DISCLOSED EMBODIMENTS

In considering two typical bar type permanent magnets: If the magnets are seen as parallel to each other when the rotating pole-piece comes to the peak interaction point, the magnetic forces will be identical when coming in from either the clockwise or counterclockwise direction. The magnetic fields are symmetrical. The magnetic interaction of the two magnets is the same as one approaches the other from any direction.

The imbalance is achieved by constraining one axis of possible movement, (Z), that being the axis chosen as that of the shaft upon which the rotor is mounted. Simply by having the rotational movement on a shaft then allows only movement in a single plane given herein as “X” and “Y” per a standard cartesian co-ordinate system.

To provide an imbalance between these magnets in order to attain a usable force is important to the physics that will make the engine design possible. The imbalance of the “pole-pair” will be used in order to enable the movement in either a linear or rotational mechanism. The magnetic imbalance and interaction is legitimate for either a linear or rotational system wherein the “linear” system is simply as if were impressed about the outer circumference of the “rotor” that is shown in the embodiment discussed herein.

By turning of the pole-pieces on either the stator or rotor, to some angle with respect to the radial of the axle, we obtain the requisite imbalance seen as the rotor pole-piece moves past the stator one. The turning of a magnet pole-piece may be done to either the rotor or stator piece; the turning of the stator pole-pieces are used in this description.

A simple measurement of the tangential force developed between these two pieces in coming together from the “Clockwise” or “Counter-clockwise” direction demonstrates the imbalance.

In a disclosed embodiment, the magnets are positioned, one group on a rotating disc which revolves, centered, within the stator and the other group on the fixed stator platen.

The “like” poles of the magnets may all be setup either in an attracting or repulsive mode depending upon the polarities chosen. For the discussion herein the repulsive mode has been selected wherein the same poles of the several magnet groups face each other as the rotor rotates. As each rotor pole-piece moves through the magnetic field of a stator pole-piece it sequentially enters the point of maximum repulsive magnetic interaction.

Since we have induced an imbalance between these pole-pieces, we can take advantage of it and ensure that the departing force is larger than the approaching force. The imbalance in the interaction, as the rotor pole approaches the stator pole the repulsive force measured is less than that of the repulsive force on the far side which then repels the rotor piece with the departing force.

The difference in the two forces multiplied by the number of rotor and stator pole-pieces as well as the number of rotor-stator groups on a given axle shaft yields the total sum of torque provided per revolution of the rotor(s) in that engine.

The chart in FIG. 4 clearly shows the imbalance in the empirical data of a pole-pair with respect to the direction of movement. The algebraic summation of the total forces measured throughout the interaction zone provides the amount of total usable force generated by this interaction.

Experiments in the laboratory showed a range of imbalance torque from 15 degrees from the parallel to a near 65-degree rotation. A 45-degree rotation with respect to the rotor radial was chosen for the system presented herein.

By placing some number of rotational pieces on the rotor and some number of pieces on the stator with all their like magnetic poles facing the air gap space between the rotor and stator we can obtain sufficient torque to prove to be utilitarian; indeed, we can use rotors that are “feet” in diameter as well as many rotors mounted on a common shaft and working with accompanying stators to produce large amounts of torque.

As is common in many engine applications an output gearing can be used to increase this effective torque by gearing the rotational speed down. Many applications can use rotational speeds of several thousand revolutions per minute down to several hundred, such as some maritime applications.

Care must be used in designing the rotors and the pole pieces mounted to them so as to maintain position at the higher revolution speeds commonly seen in modern rotating machinery. Tens of thousands of revolutions per minute are not uncommon. Solid mounting of the rotor pole pieces must be ensured to avoid catastrophic accidents.

A typical speed limiting “governor” system can be incorporated into the engine assembly by affixing a small magnetic coil pickup to monitor the engine shaft speed feedback. This information can be used to then regulate the output speed to whatever the desired operational speed is.

In the embodiment discussed herein we begin with a single rotor and stator “pole pair” with both magnets set along the magnetic “gap” region to measure the interaction that can be then be expected from the rotor-stator groups that comprise the engines or systems we will build for specific applications.

We can then determine the total engine output tangential force by using the force differential shown by a single pole-pair and multiplying that by the number of pole-pieces on the rotor, on the stator, and then the number of rotor-stator groups used in concert with one another.

In the interest of simplicity and ease of visualization, the single engine configuration can comprise numerous rotors ganged together on a common shaft with accompanying stators to multiply the effective power output.

Magnets of a typical “rod” type were used for this example; an asymmetrically designed permanent magnet may also be useful to produce the imbalance in the magnetic signature.

The physics of force interactions of this design will scale downward to include magnetic objects as small as molecular dipoles and upward to as large as is practical in the manufacture of permanent magnet components.

Safety being a concern, huge permanent magnets would prove unwieldly and dangerous to handle. Engines using a multiplicity of smaller magnetic pieces may suffice as alternatives to excessively large magnets.

The graphic representation of the actual, and empirically derived, measured resultant force is depicted (see FIG. 4) in which the “y” axis shows a gram force representation and the “x axis” representing a single pole-piece rotor movement through the range of a single stator magnetic field.

Upon analysis of the resultant integration of forces measured along the circumference, it is found that the overall resultant force is more than sufficient to do work.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while steps are presented in a given order, alternative embodiments may perform routines having steps in a different order. The teachings of the invention provided herein can be applied to other systems, not only the systems described herein. The various embodiments described herein can be combined to provide further embodiments. These and other changes can be made to the invention in light of the detailed description.

All the above references and U.S. patents and applications are incorporated herein by reference. Aspects of the invention can be modified, if necessary, to employ the systems, functions and concepts of the various patents and applications described above to provide yet further embodiments of the invention.

These and other changes can be made to the invention in light of the above detailed description. In general, the terms used in the following claims, should not be construed to limit the invention to the specific embodiments disclosed in the specification, unless the above detailed description explicitly defines such terms. Accordingly, the actual scope of the invention encompasses the disclosed embodiments and all equivalent ways of practicing or implementing the invention under the claims.

While certain aspects of the invention are presented below in certain claim forms, the inventors contemplate the various aspects of the invention in any number of claim forms.

What is claimed is:

1. A system to move a rotor by magnetic forces, the system comprising:
a) the rotor defining a center axle void; the rotor further comprising a circular outer perimeter with a plurality of rotor magnets radially disposed at the circular outer perimeter with a North polarity facing the circular outer perimeter;
b) a stator disposed in a position outside of the circular outer perimeter of the rotor, the stator comprising a plurality of stator magnets, the stator magnets disposed at an angle of 45 degrees from being radial to the stator, the stator magnets having a North polarity facing inwardly toward the rotor;
c) the rotor set in motion with the rotor motion influenced by magnetic forces exerted between the stator magnets and rotor magnets.

2. The system of claim 1 wherein the stator magnets are further angled at 45 degrees along the z axis, with the stator having a planar surface and the z axis being normal to the planar surface.

3. The system of claim 2 wherein the movement of the rotor is influenced by differential magnet forces exerted by the rotor magnets and stator magnets as the rotor rotates.

4. The system of claim 3 wherein the stator magnets are capable of movement with respect to the circular outer perimeter of the rotor.

5. The system of claim 4 wherein a magnetic imbalance with respect to repulsion forces during rotor rotation is achieved by the rotation of the stator magnets, the rotation being with respect to the radial of the rotor.

6. The system of claim 5 wherein the magnetic forces exerted between the stator magnets and rotor magnets are adjusted by changing the distance between the stator magnets and rotor magnets.

7. The system of claim 6 comprising a plurality of rotors and stators in rotational attachment using a common axle.
